(19) United States
(12) Patent Application Publication
(10) Pub. No.: US 2010/0296319 A1
(43) Pub. Date: Nov. 25, 2010

(54) POWER SOURCE MODULE WITH BROAD INPUT VOLTAGE RANGE

(75) Inventor: Yuwei Liu, Shenzhen (CN)

Correspondence Address: HARNESS, DICKEY & PIERCE, P.L.C., P.O. BOX 828, BLOOMFIELD HILLS, MI, 48303, US

(73) Assignee: LIEBERT CORPORATION, Columbus, OH (US)

(21) Appl. No.: 12/680,062

(22) PCT Filed: Sep. 8, 2008
(86) PCT No.: PCT/CN2008/072292

§ 371 Date: Jul. 26, 2010

(30) Foreign Application Priority Data
Sep. 26, 2007 (CN) 200710162358.4

(51) Int. Cl. H02M 3/335

(52) U.S. Cl. 363/21.12

(57) ABSTRACT

The present invention discloses a power source module with a broad input voltage range, which includes a first and a second power source input terminals, a rectification filter circuit, and a conversion circuit connected between the first and the second power source input terminals and the rectification filter circuit, and the conversion circuit is connected with the first and the second power source input terminals through a rectification circuit and includes a first converter and a second converter, both of which are connected in parallel for output in a low voltage operation mode and in series for output in a high voltage operation mode. The power source module with a broad input voltage range according to the invention can be implemented so that an input voltage to a single converter can be half of a high input voltage, thereby addressing the problem of a limitation upon the voltage of the power device. The connection in parallel at a low voltage can facilitate choosing an alternative transistor with relatively small current. The loss of power devices can be dispersed to facilitate a thermal design. The utilization ratio of an input direct current filter capacitor can be improved greatly in the broad voltage range. The voltage range can be altered with merely simple pre-use configuration.

### FIELD OF THE INVENTION

The present invention relates to a power source module and in particular to a power source module with a broad input voltage range.

### BACKGROUND OF THE INVENTION

There are a variety of grid systems worldwide, e.g., systems of 220V/380V in Europe and China, 208V in North America, 480V and 600V, etc. Power source modules in the current market are typically limited to an input voltage at 220V, and some of them are also compatible with 110V. An input voltage at 600V will exceed 900V after being rectified in view of 10% fluctuation over a grid. It is difficult at such a high voltage to choose power devices. A converter with a broad voltage range can be designed directly. For example, a high input voltage can be achieved with three levels. Unfortunately, such a design of the device has to consider both a current stress at a low voltage and a voltage stress at a high voltage and consequently may be costly.

### SUMMARY OF THE INVENTION

A technical issue to be addressed by the invention is how to provide a power source module with a broad input voltage range in view of the foregoing drawback in the prior art.

A technical solution adopted by the invention to address its technical issue is to construct a power source module with a broad input voltage range, which includes a first and a second power source input terminals, a rectification filter circuit, and a conversion circuit connected the first and the second power source input terminals and the rectification filter circuit, the conversion circuit being connected with the first and the second power source input terminals through a rectification circuit, wherein the conversion circuit includes a first converter and a second converter, both of which are connected in series for output in a high voltage operation mode and in parallel for output in a low voltage operation mode

In the power source module with a broad input voltage range according to the invention, an alternating current input voltage in the high voltage operation mode ranges from 380V with a negative variation up to 15% thereof to 600V with a positive variation up to 10% thereof, and an alternating current input voltage in the low voltage operation mode ranges from 208V with a negative variation up to 15% thereof to 240V with a positive variation up to 10% thereof.

In the power source module with a broad input voltage range according to the invention, the first converter and the second converter are dual transistor forward converters or dual transistor fly back converters.

Preferably, the first converter includes a first capacitor C1, a first diode D1, a second diode D2, a first switching transistor M1, a second switching transistor M2 and a first transformer T1;

wherein the first capacitor C1 is connected between a first output terminal and a second output terminal of the rectification circuit;

the first diode D1 has the anode connected with the second output terminal of the rectification circuit, and the cathode connected with a first terminal of the first transformer T1;

the second diode D2 has the anode connected with a second terminal of the first transformer T1, and the cathode connected with the first output terminal of the rectification circuit;

the first switching transistor M1 has a first terminal connected with the first terminal of the transformer, a second terminal connected with the first output terminal of the rectification circuit, and a control terminal connected with a controller; and

the second switching transistor M2 has a first terminal connected with the second output terminal of the rectification circuit, a second terminal connected with the other terminal of the first transformer T1, and a control terminal connected with the controller; and

the second converter includes a second capacitor C2, a third diode D3, a fourth diode D4, a third switching transistor M3, a fourth switching transistor M4 and a second transformer T2;

wherein the second capacitor C2 is connected between the first output terminal and the second output terminal of the rectification circuit;

the third diode D3 has the anode connected with the second output terminal of the rectification circuit, and the cathode connected with a first terminal of the second transformer T2;

the fourth diode D4 has the anode connected with a second terminal of the second transformer T2, and the cathode connected with the first output terminal of the rectification circuit;

the third switching transistor M3 has a first terminal connected with the first terminal of the transformer, a second terminal connected with the first output terminal of the rectification circuit, and a control terminal connected with the controller; and

the fourth switching transistor M4 has a first terminal connected with the second output terminal of the rectification circuit, a second terminal connected with the other terminal of the second transformer T2, and a control terminal connected with the controller.

Preferably, the first switching transistor M1, the second switching transistor M2, the third switching transistor M3 and the fourth switching transistor M4 are MOS transistors or other transistors.

Preferably, the first converter includes a first capacitor C1, a first diode D1, a second diode D2, a first switching transistor M1, a second switching transistor M2 and a first transformer T1;

wherein the first capacitor C1 has one terminal connected with a first output terminal of the rectification circuit, and the other terminal connected with the anode of the first diode D1 and a first terminal of the second switching transistor M2 at a midpoint C;

the first diode D1 has the cathode connected with a first terminal of the first transformer T1;

the second diode D2 has the anode connected with a second terminal of the first transformer T1, and the cathode connected with the first output terminal of the rectification circuit;

the first switching transistor M1 has a first terminal connected with the first terminal of the transformer, a second terminal connected with the first output terminal of the rectification circuit, and a control terminal connected with a controller; and

the second switching transistor M2 has a second terminal connected with a second terminal of the first transformer T1, and a control terminal connected with the controller; and

the second converter includes a second capacitor C2, a third diode D3, a fourth diode D4, a third switching transistor M3, a fourth switching transistor M4 and a second transformer T2;

wherein the second capacitor C2 has one terminal connected at the midpoint C, and the other terminal connected with the anode of the third diode D3 and a first terminal of the fourth switching transistor M4 at a second output terminal of the rectification circuit;

the third diode D3 has the cathode connected with a first terminal of the second transformer T2;

the fourth diode D4 has the anode connected with a second terminal of the second transformer T2, and the cathode connected with the midpoint C;

the third switching transistor M3 has a first terminal connected with the first terminal of the transformer, a second terminal connected with the midpoint C, and a control terminal connected with the controller; and

the fourth switching transistor M4 has a second terminal connected with a second terminal of the second transformer T2, and a control terminal connected with the controller.

Preferably, the first switching transistor M1, the second switching transistor M2, the third switching transistor M3 and the fourth switching transistor M4 are MOS transistors or other transistors.

Advantageous effects of the invention lie in that an input voltage to a single converter can be half of a high input voltage, thereby addressing the problem of a limitation upon the voltage of the power device. The connection in parallel at a low voltage can facilitate choosing an alternative transistor with relatively small current. The loss of power devices can be dispersed to facilitate a thermal design. The utilization ratio of an input direct current filter capacitor can be improved greatly in the broad voltage range. The voltage range can be altered with merely simple pre-use configuration.

### BRIEF DESCRIPTION OF THE DRAWINGS

The invention will be further described hereinafter with reference to the embodiments thereof and the drawings in which:

FIG. 1 is a circuit block diagram illustrating a power source module with a broad input voltage range in a low voltage mode according to a first embodiment of the invention;

FIG. 2 is a circuit block diagram illustrating a power source module with a broad input voltage range in a high voltage mode according to the first embodiment of the invention;

FIG. 3 is a circuit block diagram illustrating a power source module with a broad input voltage range in a low voltage mode according to a second embodiment of the invention;

FIG. 4 is a circuit block diagram illustrating a power source module with a broad input voltage range in a high voltage mode according to the second embodiment of the invention;

FIG. 5 is a circuit block diagram illustrating a power source module with a broad input voltage range in a low voltage mode according to a third embodiment of the invention; and

FIG. 6 is a circuit block diagram illustrating a power source module with a broad input voltage range in a high voltage mode according to the third embodiment of the invention.

### DETAILED DESCRIPTION OF THE INVENTION

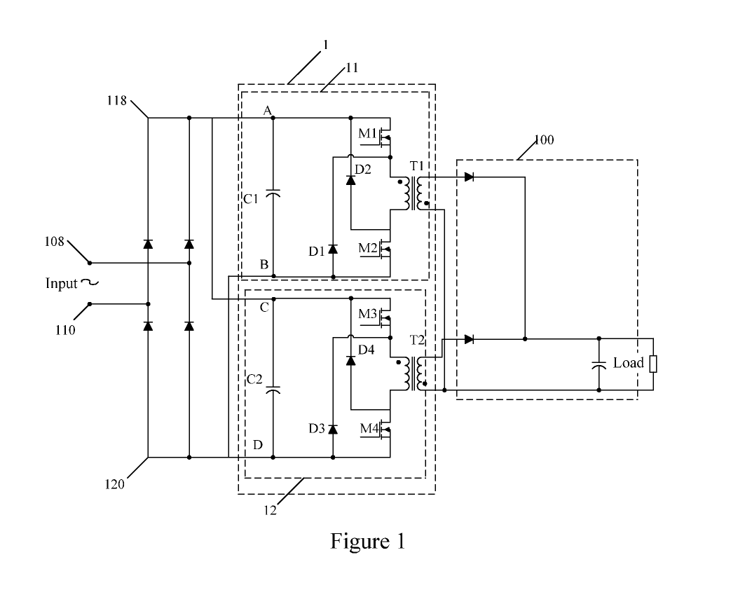

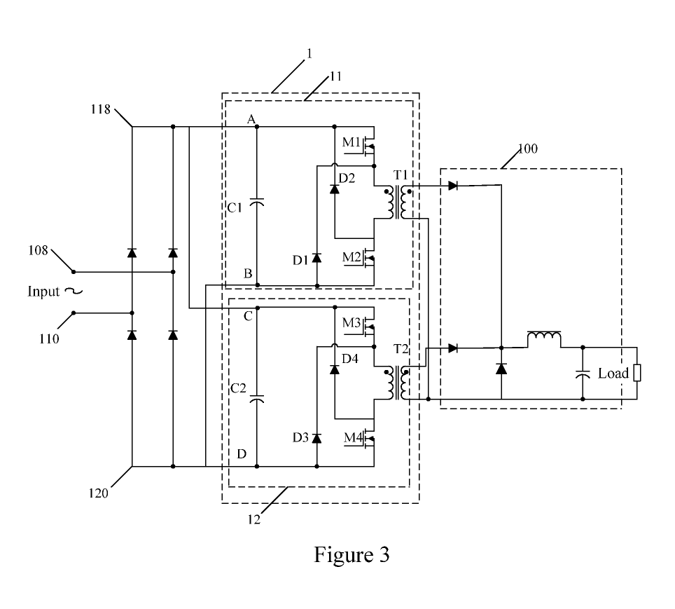

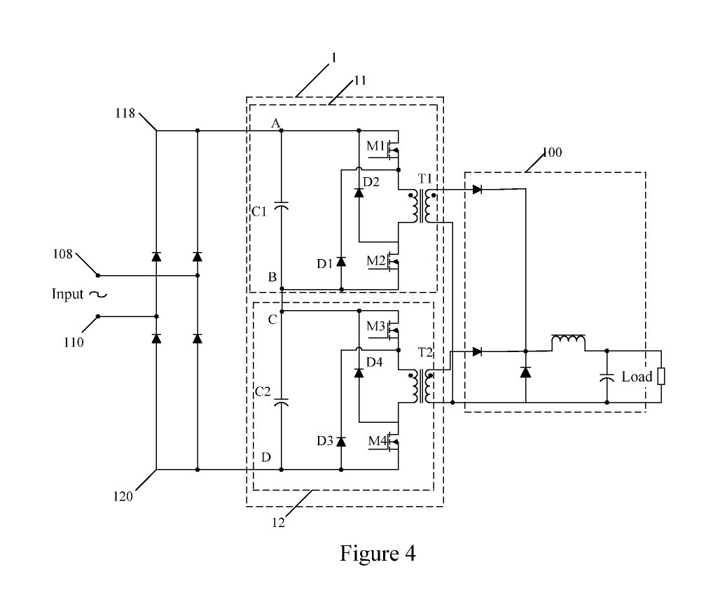

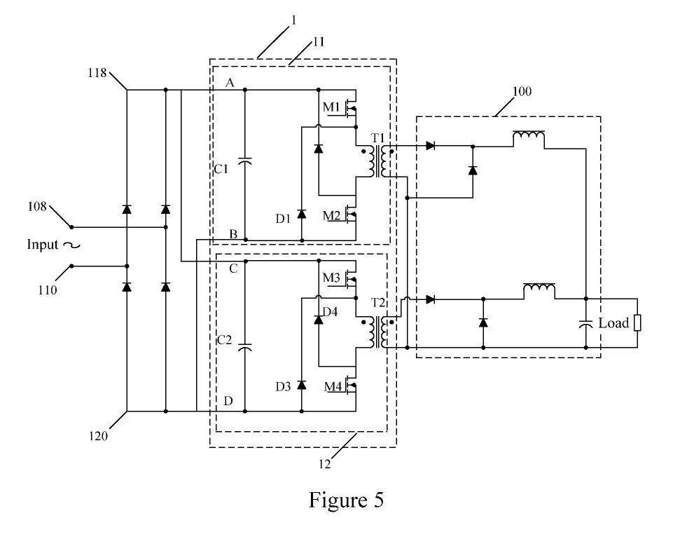

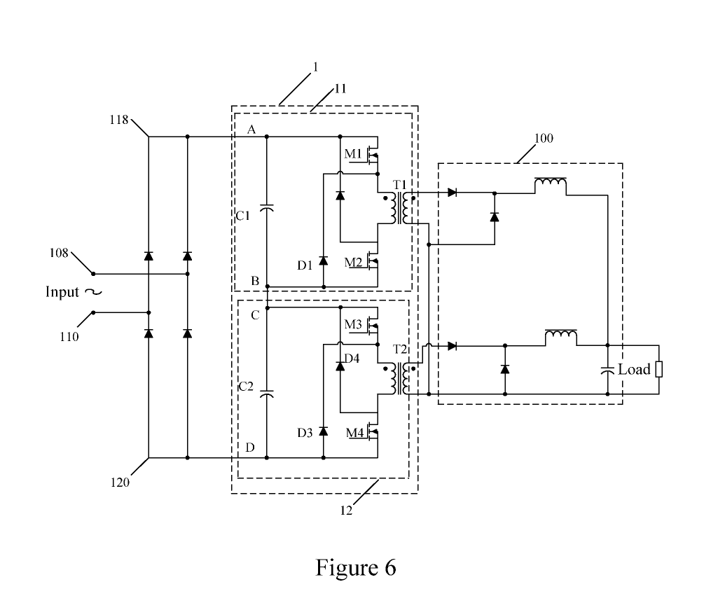

A power source module with a broad input voltage range as illustrated in FIGS. 1 to 6 includes first and second power source input terminals 108 and 110, a rectification filter circuit 100, and a conversion circuit 1 connected between the first and the second power source input terminals 108 and 110 and the rectification filter circuit 100. in which the conversion circuit 1 is connected with the first and the second power source input terminals 108 and 110 through a rectification circuit and includes a first converter 11 and a second converter 12, both of which are connected in parallel for output in a low voltage operation mode and in series for output in a high voltage operation mode. Fly back conversion circuits are adopted in a first embodiment, forward conversion circuits are adopted in a second embodiment, and dual inductors are adopted at the secondary sides in a third embodiment.

An alternating current input voltage in the high voltage operation mode ranges from 380V with a negative variation up to 15% thereof to 600V with a positive variation up to 10% thereof, and an alternating current input voltage in the low voltage operation mode ranges from 208V with a negative variation up to 15% thereof to 240V with a positive variation up to 10% thereof.

A control chip of the converters sends two symmetric PWM pulses with a difference of 180 degrees to control the two converters and other transistor switches respectively. In a stable control loop, the two PWM pulses are identical in width, the two forward conversion circuits are identical in output power, and a uniform voltage can be achieved with an input rectification filter capacitor in the series mode.

FIGS. 1, 3 and 5 illustrates structures of the first and the second converters connected in parallel in the conversion circuit 1 in the low voltage operation mode according to the first, second and third embodiments, respectively. Particularly, the first converter 11 includes a first capacitor C1, a first diode D1, a second diode D2, a first switching transistor M1, a second switching transistor M2 and a first transformer T1, where the first capacitor C1 is connected between a first output terminal 118 and a second output terminal 120 of the rectification circuit, the first diode D1 has the anode connected with the second output terminal 120, and the cathode connected with a first terminal of the first transformer T1, the second diode D2 has the anode connected with a second terminal of the first transformer T1, and the cathode connected with the first output terminal 118 of the rectification circuit, the first switching transistor M1 has a first terminal connected with the first terminal of the transformer, a second terminal connected with the first output terminal 118, and a control terminal connected with a controller, and the second switching transistor M2 has a first terminal connected with the second output terminal 120, a second terminal connected with the other terminal of the first transformer T1, and a control terminal connected with the controller. The second converter 12 includes a second capacitor C2, a third diode D3, a fourth diode D4, a third switching transistor M3, a fourth switching transistor M4 and a second transformer T2, where the second capacitor C2 is connected between the first output terminal 118 and the second output terminal 120 of the rectification circuit, the third diode D3 has the anode connected with the second output terminal 120, and the cathode connected with a first terminal of the second transformer T2, the fourth diode D4 has the anode connected with a second terminal of the second transformer T2, and the cathode connected with the first output terminal 118, the third switching transistor M3 has a first terminal connected with the first terminal of the transformer, a second terminal connected with the first output terminal 118, and a control terminal connected with the controller, and the fourth switching transistor M4 has a first terminal connected with the second output terminal 120, a second terminal connected with the other terminal of the second transformer T2, and a control terminal connected with the controller. The first switching transistor M1, the second switching transistor M2, the third switching transistor M3 and the fourth switching transistor M4 are MOS transistors or other transistors. As desired differently, midpoints A, B, C and D can be shorted appropriately with a conductive wire, a relay, etc., to achieve a voltage ranging as required.

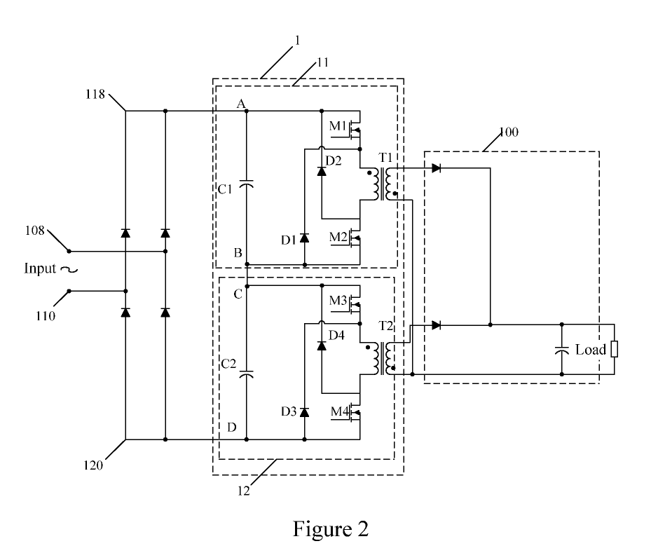

FIGS. 2, 4 and 6 illustrates structures of the first and the second converters connected in series in the conversion circuit 1 in the high voltage operation mode according to the first, second and third embodiments, respectively. Particularly, the first converter 11 includes a first capacitor C1, a first diode D1, a second diode D2, a first switching transistor M1, a second switching transistor M2 and a first transformer T1, where the first capacitor C1 has one terminal connected with a first output terminal 118 of the rectification circuit, and the other terminal connected with the anode of the first diode D1 and a first terminal of the second switching transistor M2 at a midpoint C, the first diode D1 has the cathode connected with a first terminal of the first transformer T1, the second diode D2 has the anode connected with a second terminal of the first transformer T1, and the cathode connected with the first output terminal 118, the first switching transistor M1 has a first terminal connected with the first terminal of the transformer, a second terminal connected with the first output terminal 118, and a control terminal connected with a controller, and the second switching transistor M2 has a second terminal connected with the other terminal of the first transformer T1, and a control terminal connected with the controller. The second converter 12 includes a second capacitor C2, a third diode D3, a fourth diode D4, a third switching transistor M3, a fourth switching transistor M4 and a second transformer T2, where the second capacitor C2 has one terminal connected at the midpoint C, and the other terminal connected with the anode of the third diode D3 and a first terminal of the fourth switching transistor M4 at a second output terminal 120 of the rectification circuit, the third diode D3 has the cathode connected with a first terminal of the second transformer T2, the fourth diode D4 has the anode connected with a second terminal of the second transformer T2, and the cathode connected with the midpoint C, the third switching transistor M3 has a first terminal connected with the first terminal of the transformer, a second terminal connected with the midpoint C, and a control terminal connected with the controller, and the fourth switching transistor M4 has a second terminal connected with the other terminal of the second transformer T2, and a control terminal connected with the controller. The first switching transistor M1, the second switching transistor M2, the third switching transistor M3 and the fourth switching transistor M4 are MOS transistors or other transistors. As desired differently, midpoints A, B, C and D can be shorted appropriately with a conductive wire, a relay, etc., to achieve a voltage ranging as required.

The invention has been described in connection with the several embodiments thereof, and those skilled in the art shall appreciate that various variations and equivalent substitutions can be made to the invention without departing from the scope of the invention. Moreover, various modifications can be made to the invention for particular scenarios or specific situations without departing from the scope of the invention. Accordingly, the invention will not be limited to the disclosed embodiments but shall encompass all those embodiments falling into the scope of the claims appended to the invention.

1. A power source module with a broad input voltage range, comprising: a first and a second power source input terminals, a rectification filter circuit, and a conversion circuit connected between the first and the second power source input terminals and the rectification filter circuit, the conversion circuit being connected with the first and the second power source input terminals through a rectification circuit, wherein the conversion circuit comprises a first converter and a second converter, both of which are connected in series for output in a high voltage operation mode and in parallel for output in a low voltage operation mode.

2. The power source module with a broad input voltage range according to claim 1, wherein an alternating current input voltage in the high voltage operation mode ranges from 380V with a negative variation up to 15% thereof to 600V with a positive variation up to 10% thereof, and an alternating current input voltage in the low voltage operation mode ranges from 208V with a negative variation up to 15% thereof to 240V with a positive variation up to 10% thereof.

3. The power source module with a broad input voltage range according to claim 2, wherein the first converter and the second converter are dual transistor forward converters or dual transistor fly back converters.

4. The power source module with a broad input voltage range according to claim 1, wherein in the low voltage operation mode, the first converter comprises a first capacitor C1, a first diode D1, a second diode D2, a first switching transistor M1, a second switching transistor M2 and a first transformer T1;
wherein the first capacitor C1 is connected between a first and a second output terminals of the rectification circuit;
the first diode D1 has the anode connected with the second output terminal of the rectification circuit, and the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a first terminal connected with the second output terminal of the rectification circuit, a second terminal connected with the second terminal of the first transformer T1, and a control terminal connected with the controller; and
the second converter comprises a second capacitor C2, a third diode D3, a fourth diode D4, a third switching transistor M3, a fourth switching transistor M4 and a second transformer T2;
wherein the second capacitor C2 is connected between the first and the second output terminals of the rectification circuit;
the third diode D3 has the anode connected with the second output terminal of the rectification circuit, and the cathode connected with a first terminal of the second transformer T2;
the fourth diode D4 has the anode connected with a second terminal of the second transformer T2, and the cathode connected with the first output terminal of the rectification circuit;
the third switching transistor M3 has a first terminal connected with the first terminal of the transformer, a second terminal connected with the first output terminal of the rectification circuit, and a control terminal connected with a controller; and
the fourth switching transistor M4 has a first terminal connected with the second output terminal of the rectification circuit, a second terminal connected with the second terminal of the second transformer T2, and a control terminal connected with the controller.

5. The power source module with a broad input voltage range according to claim 4, wherein the first switching transistor M1, the second switching transistor M2, the third switching transistor M3 and the fourth switching transistor M4 are MOS transistors or other transistors.

6. The power source module with a broad input voltage range according to claim 1, wherein in the high voltage operation mode, the first converter comprises a first capacitor C1, a first diode D1, a second diode D2, a first switching transistor M1, a second switching transistor M2 and a first transformer T1;
wherein the first capacitor C1 has one terminal connected with a first output terminal of the rectification circuit, and the other terminal connected with the anode of the first diode D1 and a first terminal of the second switching transistor M2 at a midpoint C;
the first diode D1 has the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a second terminal connected with a second terminal of the first transformer T1, and a control terminal connected with the controller; and
the second converter includes a second capacitor C2, a third diode D3, a fourth diode D4, a third switching transistor M3, a fourth switching transistor M4 and a second transformer T2;
wherein the second capacitor C2 has one terminal connected at the midpoint C, and the other terminal connected with the anode of the third diode D3 and a first terminal of the fourth switching transistor M4 at a second output terminal of the rectification circuit;
the third diode D3 has the cathode connected with a first terminal of the second transformer T2;
the fourth diode D4 has the anode connected with a second terminal of the second transformer T2, and the cathode connected with the midpoint C;
the third switching transistor M3 has a first terminal connected with the first terminal of the transformer, a second terminal connected with the midpoint C, and a control terminal connected with a controller; and
the fourth switching transistor M4 has a second terminal connected with the second terminal of the second transformer T2, and a control terminal connected with the controller.

7. The power source module with a broad input voltage range according to claim 6, wherein the first switching transistor M1, the second switching transistor M2, the third switching transistor M3 and the fourth switching transistor M4 are MOS transistors or other transistors.

8. The power source module with a broad input voltage range according to claim 2, wherein in the low voltage operation mode, the first converter comprises a first capacitor C1, a first diode D1, a second diode D2, a first switching transistor M1, a second switching transistor M2 and a first transformer T1;
wherein the first capacitor C1 is connected between a first and a second output terminals of the rectification circuit;
the first diode D1 has the anode connected with the second output terminal of the rectification circuit, and the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a first terminal connected with the second output terminal of the rectification circuit, a second terminal connected with the second terminal of the first transformer T1, and a control terminal connected with the controller; and
the second converter comprises a second capacitor C2, a third diode D3, a fourth diode D4, a third switching transistor M3, a fourth switching transistor M4 and a second transformer T2;
wherein the second capacitor C2 is connected between the first and the second output terminals of the rectification circuit;
the third diode D3 has the anode connected with the second output terminal of the rectification circuit, and the cathode connected with a first terminal of the second transformer T2;
the fourth diode D4 has the anode connected with a second terminal of the second transformer T2, and the cathode connected with the first output terminal of the rectification circuit;
the third switching transistor M3 has a first terminal connected with the first terminal of the transformer, a second terminal connected with the first output terminal of the rectification circuit, and a control terminal connected with a controller; and
the fourth switching transistor M4 has a first terminal connected with the second output terminal of the rectification circuit, a second terminal connected with the second terminal of the second transformer T2, and a control terminal connected with the controller.

9. The power source module with a broad input voltage range according to claim 3, wherein in the low voltage operation mode, the first converter comprises a first capacitor C1, a first diode D1, a second diode D2, a first switching transistor M1, a second switching transistor M2 and a first transformer T1;
wherein the first capacitor C1 is connected between a first and a second output terminals of the rectification circuit;
the first diode D1 has the anode connected with the second output terminal of the rectification circuit, and the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a first terminal connected with the second output terminal of the rectification circuit, a second terminal connected with the second terminal of the first transformer T1, and a control terminal connected with the controller; and
the second converter comprises a second capacitor C2, a third diode D3, a fourth diode D4, a third switching transistor M3, a fourth switching transistor M4 and a second transformer T2;
wherein the second capacitor C2 is connected between the first and the second output terminals of the rectification circuit;
the third diode D3 has the anode connected with the second output terminal of the rectification circuit, and the cathode connected with a first terminal of the second transformer T2;
the fourth diode D4 has the anode connected with a second terminal of the second transformer T2, and the cathode connected with the first output terminal of the rectification circuit;
the third switching transistor M3 has a first terminal connected with the first terminal of the transformer, a second terminal connected with the first output terminal of the rectification circuit, and a control terminal connected with a controller; and
the fourth switching transistor M4 has a first terminal connected with the second output terminal of the rectification circuit, a second terminal connected with the second terminal of the second transformer T2, and a control terminal connected with the controller.

10. The power source module with a broad input voltage range according to claim 2, wherein in the high voltage operation mode, the first converter comprises a first capacitor C1, a first diode D1, a second diode D2, a first switching transistor M1, a second switching transistor M2 and a first transformer T1;
wherein the first capacitor C1 has one terminal connected with a first output terminal of the rectification circuit, and the other terminal connected with the anode of the first diode D1 and a first terminal of the second switching transistor M2 at a midpoint C;
the first diode D1 has the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a second terminal connected with a second terminal of the first transformer T1, and a control terminal connected with the controller; and
the second converter includes a second capacitor C2, a third diode D3, a fourth diode D4, a third switching transistor M3, a fourth switching transistor M4 and a second transformer T2;
wherein the second capacitor C2 has one terminal connected at the midpoint C, and the other terminal connected with the anode of the third diode D3 and a first terminal of the fourth switching transistor M4 at a second output terminal of the rectification circuit;
the third diode D3 has the cathode connected with a first terminal of the second transformer T2;
the fourth diode D4 has the anode connected with a second terminal of the second transformer T2, and the cathode connected with the midpoint C;
the third switching transistor M3 has a first terminal connected with the first terminal of the transformer, a second terminal connected with the midpoint C, and a control terminal connected with a controller; and
the fourth switching transistor M4 has a second terminal connected with the second terminal of the second transformer T2, and a control terminal connected with the controller.

11. The power source module with a broad input voltage range according to claim 3, wherein in the high voltage operation mode, the first converter comprises a first capacitor C1, a first diode D1, a second diode D2, a first switching transistor M1, a second switching transistor M2 and a first transformer T1;
wherein the first capacitor C1 has one terminal connected with a first output terminal of the rectification circuit, and the other terminal connected with the anode of the first diode D1 and a first terminal of the second switching transistor M2 at a midpoint C;
the first diode D1 has the cathode connected with a first terminal of the first transformer T1;
the second diode D2 has the anode connected with a second terminal of the first transformer T1, and the cathode connected with the first output terminal of the rectification circuit;
the first switching transistor M1 has a first terminal connected with the first terminal of the transformer, a second terminal connected with the first output terminal of the rectification circuit, and a control terminal connected with a controller; and
the second switching transistor M2 has a second terminal connected with a second terminal of the first transformer T1, and a control terminal connected with the controller; and
the second converter includes a second capacitor C2, a third diode D3, a fourth diode D4, a third switching transistor M3, a fourth switching transistor M4 and a second transformer T2;
wherein the second capacitor C2 has one terminal connected at the midpoint C, and the other terminal connected with the anode of the third diode D3 and a first terminal of the fourth switching transistor M4 at a second output terminal of the rectification circuit;
the third diode D3 has the cathode connected with a first terminal of the second transformer T2;
the fourth diode D4 has the anode connected with a second terminal of the second transformer T2, and the cathode connected with the midpoint C;
the third switching transistor M3 has a first terminal connected with the first terminal of the transformer, a second terminal connected with the midpoint C, and a control terminal connected with a controller; and
the fourth switching transistor M4 has a second terminal connected with the second terminal of the second transformer T2, and a control terminal connected with the controller.
